(19) United States
(12) Patent Application Publication
(10) Pub. No.: US 2010/0228586 A1
(43) Pub. Date: Sep. 9, 2010

(54) SYSTEM AND METHOD OF MONITORING PRIVATE UTILITIES

(76) Inventor: Lloyd Frank Hay, Langley (CA)

Correspondence Address: SCHWABE, WILLIAMSON & WYATT, P.C., 1420 FIFTH, SUITE 3400, SEATTLE, WA, 98101-4010, US

(21) Appl. No.: 12/397,223

(22) Filed: Mar. 3, 2009

(51) Int. Cl. G06Q 10/00; G06Q 50/00

(52) U.S. Cl. 705/8; 705/7

(57) ABSTRACT

A method and system is provided for allowing interested parties in a private utility, such as owners, government regulators and maintenance providers, to access and provide information about that utility. The system provides reminders and alerts to the interested parties about maintenance deadlines and alarms. Each interested party only has access to those private utilities in which they have an interest, for example a government regulator has access only to those private utilities within their jurisdiction, and a maintenance provider only has access to those private utilities with which they have a maintenance contract. The system provides a means for those interested parties to quickly determine which private utilities require their immediate attention.

### RELATED APPLICATION

This application claims priority to prior-filed Canadian Patent Application (application number pending) filed on Mar. 2, 2009 and titled “System and Method of Monitoring Private Utilities.”

### FIELD OF THE INVENTION

This invention relates to management of private utilities, and particularly private septic systems.

### BACKGROUND

Within North America over 35% of residential and commercial facilities are served by utilities that are privately owned by the landowner of the property serviced by the utility. The utilities may include any one of or combination of: an onsite sewage treatment; sewage lift stations; and a drinking water treatment system. Onsite sewage or water treatment systems, also referred to herein as private utilities, include several components that treat the sewage to particular levels and disperse the treated sewage, also known as treated effluent, into either a soil based or surface body of water receiving area. In some circumstances the treated effluent is treated to such a high level that the effluent is used within a facility to flush toilets and urinals as well as for uses such as vehicle washing and other sewage wastewater applications.

These private utilities are typically regulated by Federal, State or Provincial regulations regarding their design, installation and maintenance. The increasing use of these privately held, operated, and maintained private utilities require governments to allocate human and financial resources to manage and administer the regulations.

Designers of these private utilities design and size the utility to meet the regulations that typically require certain fixed values for estimated daily flow rates and mass organic loading rates for a particular type of system.

Users of these types of utilities may not be aware of the limits of the utility, or how to properly service and provide preventative maintenance, or to service or repair parts. Users of private utilities, such as onsite septic systems and sewage treatment systems often do not conduct the scheduled maintenance as required by the system designer or equipment manufacturer. Maintenance providers of these types of utilities often do not know and do not have access to the system's design, layout or specifications, and the required scheduled maintenance.

Regulators in many jurisdictions are required to ensure that maintenance of privately owned utilities is conducted on time and in accordance with the designer's scheduled maintenance requirements. Typically, there is no central registry online or offline that the regulator can use to assure compliance by the user and the goods and services provided by the industry.

Designers of these types of utilities have little to no ability to follow-up on the performance of their design on private lands.

Local governments are reluctant to subdivide privately owned land in communities that use privately owned utilities on private land due to a concern about the lack of ability to enforce maintenance on these private utilities.

There exist parts of private utilities that convey, by electronic signal, operational and performance characteristics of the utility, that allow a remote operator to adjust any or all components of the utility. However these parts do not allow for the storage of other materials such as drawings, site layout, system specifications, reports of other kinds and photos. Also they do not allow for multiple users to access the information or for a single user to access information about multiple sites of private utilities.

### SUMMARY OF THE INVENTION

The invention provides a web site providing access to regulators, designers, maintenance providers and the utility owner, each having a specific level of access and ability to make additions to the information relating to a particular private utility.

The invention provides a web site for monitoring privately owned utilities such as sewage lift stations and water treatment systems, that is a tool for governments, designers, maintenance providers and the users of such utilities to ensure compliance to regulations, proper use of the utility by users and assistance in meeting obligations for maintenance that provide an increased level of public health and environmental protection proactively.

The invention also provides an online method of managing the many private utilities within a regulator's jurisdiction by providing automated notifications of schedule maintenance, name of property owner, tenant, contact information, site location, utility design, layout and specifications and a reporting process regarding non-compliant utility locations and thereby reduces the resources that a government needs to manage and administer these utilities. Regulators may also add photos of the installation of the utility and details of the current or future utility appearance to document and support the issuance of permits to construct or use the utility. The regulators may add notes to advise designers, maintenance providers or future owners of the utility of issues or matters that may need attention. The regulators may view the maintenance completed and any effluent sample results as entered by the maintenance provider.

The web site according to the invention manages, monitors and tracks the use and historical operation, function, performance of the private utility that allows a designer to confirm that the utility has met the design, or to determine corrective measures based on accurate information.

The web site according to the invention allows for data and performance of electro-mechanical components of a privately owned utility to be received for determining trends and producing flow charts of the operation and function of the utility without having to enter private property, and at any time of the year regardless of climate conditions. This allows a utility designer to ensure that the design is in compliance with regulations, operates and performs as designed, is maintained as required and allows the designer to respond to any re-design or upgrade of the utility based on actual data and performance of the utility. Designers may also add photos of the installation of the utility and current or future utility appearance. Designers may add notes to advise regulators, maintenance providers or future owners of the utility of issues or matters that may need attention.

Designers may see their private utility designs used and maintained appropriately, and receive feedback so that new designs take into account real world conditions, and, receive details to provide effective and efficient upgrades or re-designs if necessary.

The invention allows for the managing, monitoring and tracking of the use and historical operation, function, performance of a utility so that a maintenance provider can take preventative maintenance measures to ensure that the utility is in compliance with the regulations.

Maintenance providers receive automatic notifications for scheduled maintenance or about alarm conditions at the location of the utility. The maintenance provider may store maintenance reports and retain a complete history of any issues or matters relating to a utility to use to better assess problems and solutions for a utility not in compliance with regulations.

The invention can be used to provide the maintenance provider information about the components or parts of a utility, and can identify such components or parts by brand, make and model, that may need service or repair, before the maintenance provider leaves their locale to attend to the utility, thereby reducing maintenance costs to both the maintenance provider and the owner of the utility. Where required by regulation, the maintenance provider may store effluent sample test results, or may store photos of the utilities' condition before, during and after the maintenance. Maintenance providers may manage their staff and resources more effectively in conducting scheduled maintenance or responding to alarm notifications with the appropriate tools and parts.

The system according to the invention provides to the utility owner a tool to monitor their use of the utility to maintain compliance with any regulations and design specifications. If any dispute regarding the utilities' operation, function and performance arises between the owner and the designer, regulator, installer or maintenance provider, the web site provides to the owner documentation and history sufficient to clarify the responsible party or parties.

Owners of utilities also benefit by having the utility operate and be maintained in accordance with the design and regulation of the utility, and thereby protect the owner's property value from decline from a malfunctioning utility thereby potentially causing a public nuisance or health hazard that may take many thousands of dollars to correct.

Local governments that wish to pass bylaws for subdivisions based on the use of private utilities, may use the system according to the invention to provide a management and monitoring tool to ensure that maintenance is conducted.

The web site according to the invention also provides governments, particularly local governments, a tool to assist in creating bylaws that enforce maintenance, by having a tool to ensure that the maintenance is, in fact, conducted.

The system according to the invention can relieve a resource allocation burden on a government by having the web site automatically manage and track any and all obligations of the utility owner for compliance. The web site can contact a regulator when a non-compliance problem is not corrected in a timely manner, allowing the government to allocate its human and financial resources elsewhere unless there is a non-compliance issue that requires direct intervention by the regulator.

Local governments desiring to use onsite private utilities, such as a septic system for land use planning and sub-division creation, with an enforceable maintenance plan, can use the web site as a tool for managing and monitoring maintenance. This removes the cost to the local government of the construction or expansion of sewage collection systems to a central publicly owned and operated municipal sewage treatment works.

A system for providing notifications is provided, including: a server accessible by a computer operated by a user associated with a plurality of private utilities, the server in communication with a database, the database containing a plurality of records, each of the records relating to a private utility; the records including the date of the next scheduled maintenance of the private utility, and at least one of the records containing an email address associated with the user; wherein within a predetermined time of the next scheduled maintenance, the server sends an email, fax or automated voice notification to the user reminding the user of the next scheduled maintenance.

The user may be a maintenance provider, and when the maintenance provider provides maintenance to a private utility, the maintenance provider accesses the server and provides a maintenance date to the record associated with the private utility, and a government regulator may access the system to confirm the maintenance provider has provided maintenance to private utilities within a jurisdiction associated with the government regulator. The record may also include contact information about the government regulator and an owner, and if the maintenance is not performed on the private utility according to the scheduled maintenance, then the government regulator may contact the owner.

The record of a private utility may include information relating to repairs made to the private utility and the configuration of the private utility.

A method of providing a notification is provided, including: a) providing an email address, or fax or phone number of a maintenance provider to a server, b) storing the email address or fax or phone number in a database in a plurality of records, each of the records relating to a private utility, each of the records associated with the maintenance provider; c) for each of the records storing a maintenance schedule for the private utility, the maintenance schedules including a next scheduled maintenance date; d) when a predetermined time occurs prior to the next scheduled maintenance date, the server sending an email, fax or automated voice notification to the maintenance provider.

A method of monitoring a plurality of private utilities is provided, including: a) providing a database on a server accessible by a government regulator, the database containing a plurality of records, each of said records relating to a private utility; at least one of the private utilities within a jurisdiction associated with the government regulator; b) providing a maintenance schedule for each of the public utilities, the maintenance schedule including a next scheduled maintenance date; c) providing access to the maintenance schedule by a maintenance provider, wherein the maintenance provider records in the maintenance schedule when maintenance is performed; d) displaying, when the government regulator accesses the database, the records relating to private utilities within the jurisdiction of the government regulator; and e) displaying to the government regulator at a web site provided by the server, a list of the private utilities within the jurisdiction, and indicating which of the private utilities have not received maintenance according to the maintenance schedule.

### DESCRIPTION OF THE FIGURES

FIG. 1 is block drawing showing the system according to the invention;

FIG. 2 is an embodiment of a web page according to the invention wherein a user can edit their profile;

FIG. 3 is an embodiment of a web page according to the invention, showing a home page accessible by a user;

FIG. 4 is an embodiment of a web page according to the invention wherein users may select a report;

FIG. 5 is a is an embodiment of a web page according to the invention wherein users may generate an alarm report;

FIGS. 6A and 6B show an embodiment of a web page according to the invention, displaying an alarm report;

FIG. 7 is an embodiment of a web page according to the invention wherein users may generate a trend data report;

FIG. 8 is an embodiment of a web page according to the invention, showing a trend data report;

FIGS. 9A, 9B, and 9C are an embodiment of a web page according to the invention, relating to a single site.

FIG. 10 is a flow chart showing the system used to generate an alert; and

FIG. 11 is a flow chart showing the system used to monitor maintenance.

### DESCRIPTION OF THE INVENTION

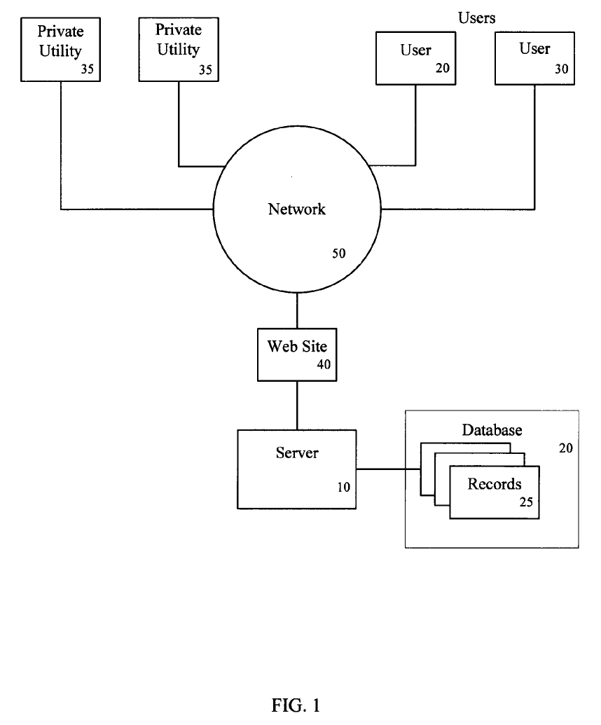

As seen in FIG. 1, the system according to the invention includes server 10. Server 10 may be a computer or a series of computers performing conventional server functions. Server 10 has access to database 20, which stores records 25 relating to private utilities 35. The term “private utility”, as used in this document, means a privately owned (as opposed to publicly owned, such as a government owned corporation) onsite sewage treatment system or water treatment site.

Server 10 is accessible to users 30 through web site 40 accessed through a network 50, such as the Internet. Users 30 may include owners of private utilities, designers of private utilities, maintenance providers to private utilities, and government regulators of private utilities. A government regulator is a person or other entity who has a job function that includes monitoring private utilities to ensure they are maintained in accordance with the regulations of the jurisdiction in which the private utilities is located.

Web site 40 is operated and managed by an administrator, that through the web site 40, sets passwords for users 30 to allow users 30 to access web site 40 with appropriate restrictions such as, to view records only, to upload information to a particular subset of records 25, and/or to enter maintenance data and reports to a particular subset of records 25.

The administrator categorizes users 30 into appropriate categories such as: Regulator; Designer; Maintenance Provider; and Owner of the property in which the utility is located. Each user 30 should only have access to records relating to private utilities 35 that they have a need to access information. For example, regulators will have access to records 25 relating to private utilities 35 located within their jurisdiction. Designers will have access to records 25 of private utilities 35 that they have designed. Maintenance providers will have access to records 25 of private utilities 35 that they are responsible for maintaining, and owners will have access to records 25 of private utilities 35 on properties they own.

The administrator enters the individual private utilities and location details into appropriate records 25 and can set the level of user access and viewing privileges to each individual private utilities record 25.

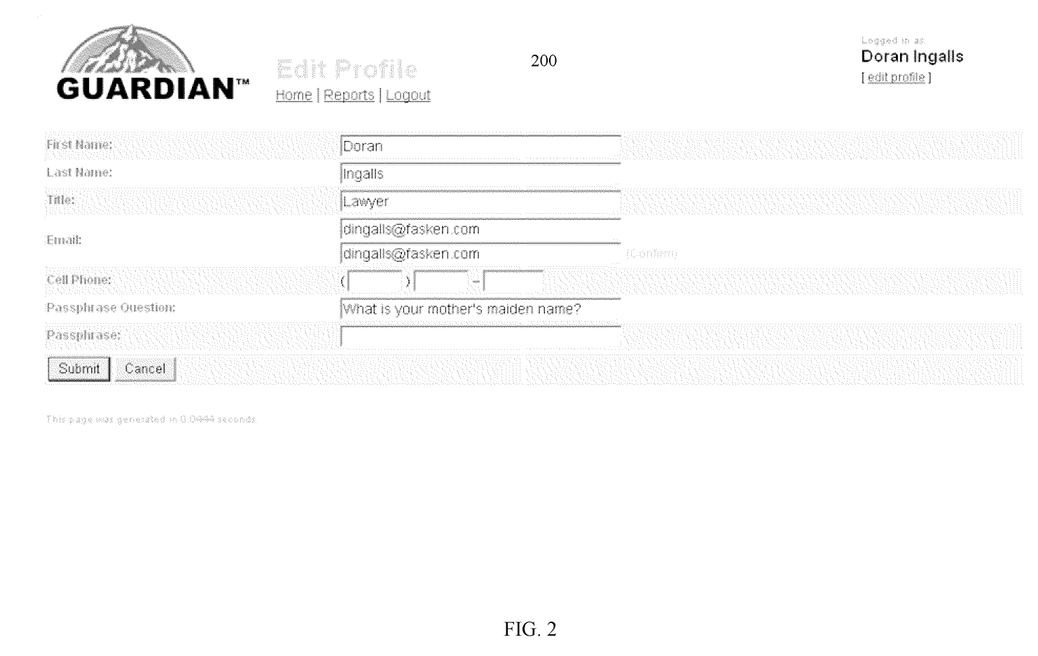

Users 30 register with web site 40 by providing information to the administrator. As seen in FIG. 2, users can also edit their user profile at the Edit Profile Page 200, by amending their contact information, name, title and a question that, should the user forget their password, need be answered before server 10 provides an email with the password.

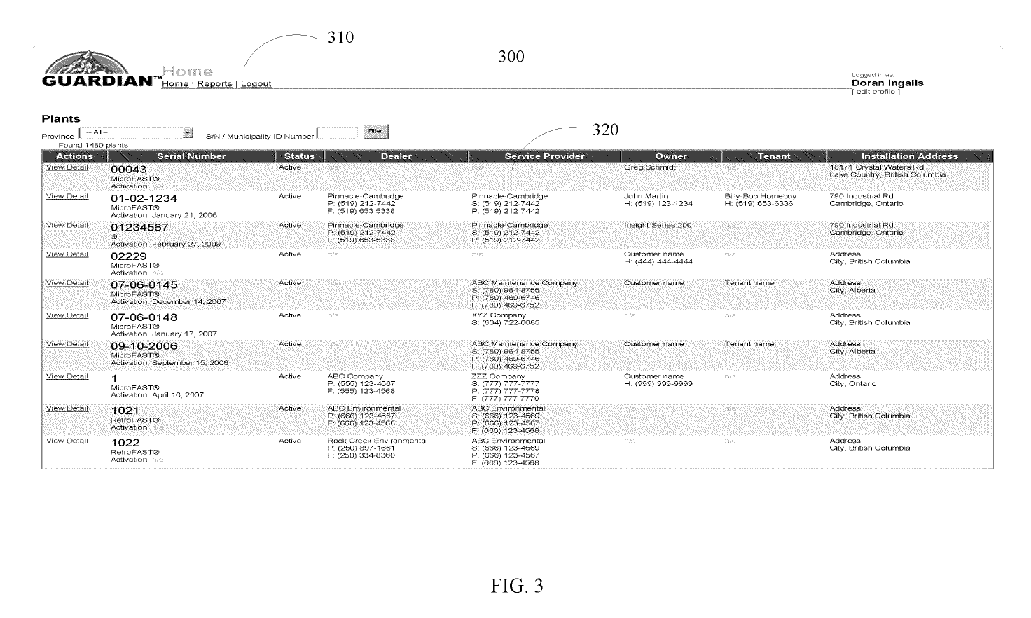

Web site 40 presents users 30, after user 30 logs in, at home page 300, a table or list 320 showing the private utilities 35 that they have access to, as seen in FIG. 3. Menu 310 allows users 30 to select home page 300, or view reports. Alternatively, users 30 can edit their profile, by linking to the Edit Profile Page 200.

In an embodiment of the invention, the listing of a private utility 35 is bolded in red and placed at the top of the list 320 if those private utilities have provided a notification to a user 30 and have not had a response from the user 30. This allows a user 30 to immediately determine which private utilities 35 require attention.

List 320 includes information about the private utilities 35 to which the user has access. For each such private utilities, the list will indicate: (a) the serial number, brand name of the private utilities 35 and the activation date; (b) the status of private utilities 35; (c) the dealer who provided private utilities 35; (d) the maintenance provider who is responsible for maintaining private utilities 35; (e) the owner of the property on which private utilities 35 is located; (f) if applicable, the tenant(s) on the property; and (f) the address of the property. A link is provided so that user 35 can access detailed information about private utilities 35.

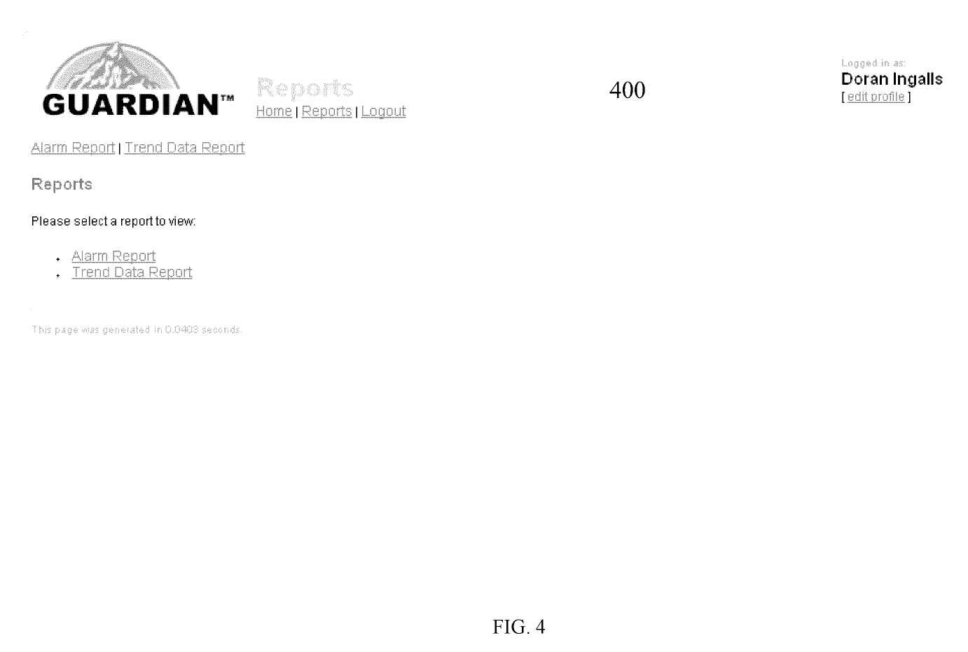

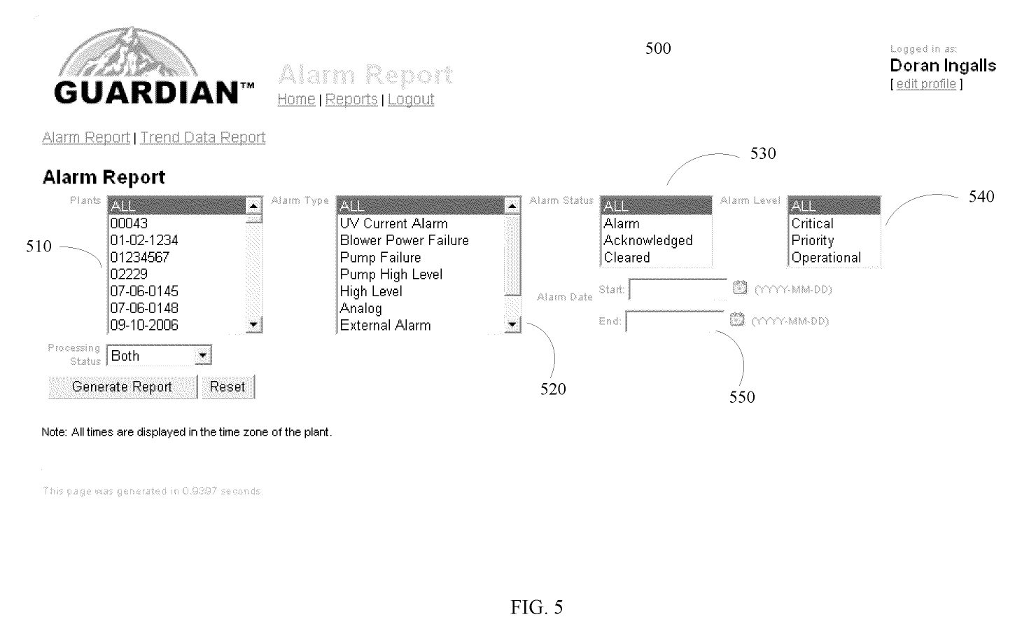

As seen in FIG. 4, when user 30 selects “Reports”, Reports web page 400 allows user 30 to select “Alarm Reports” or “Trend Data Reports”. If user 30 selects “Alarm Reports” they are linked to the Alarm Report web page 500, as seen in FIG. 5, which provides menus that allow user 30 to create the alarm reports. These menus include a list of private utility serial numbers 510, alarm types 520, alarm status 530, alarm level 540 and a date range 550.

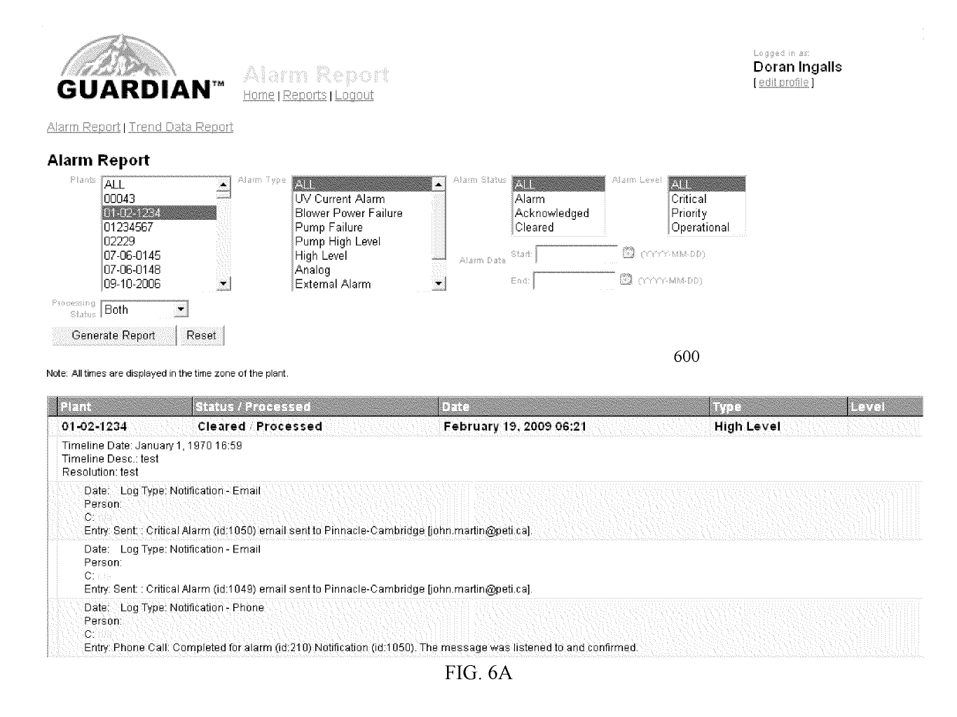

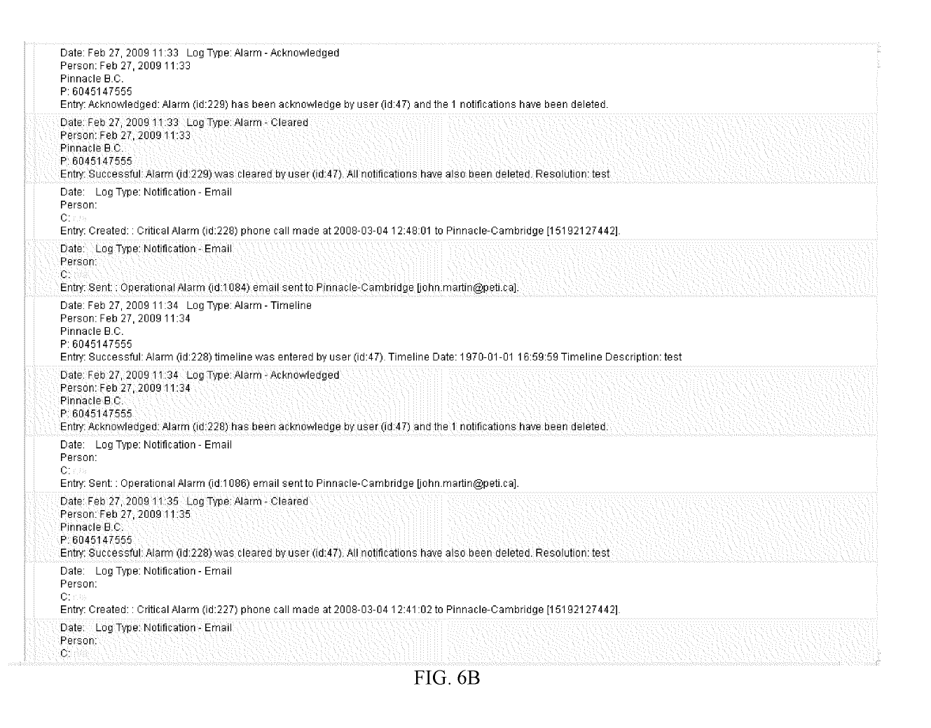

A representative alarm report 600 is shown in FIGS. 6A and 6B. A list of alarms relating to the selected private utilities is provided. Relevant information includes the date of the alarm, and the method of notification (typically via email, other options include a pre-recorded voice message provided by telephone, or a fax). Also a note about the particular alarm and the result of that alarm is provided. Indicators may also be provided such as a “STATUS/PROCESSED” indicator which allows user 30 to know if the alarm or notification has been acknowledged, cleared or unanswered. A DATE field provides the real time the alarm is sent and the TYPE field indicates the importance of an alarm, e.g. if it is critical, operational or a priority.

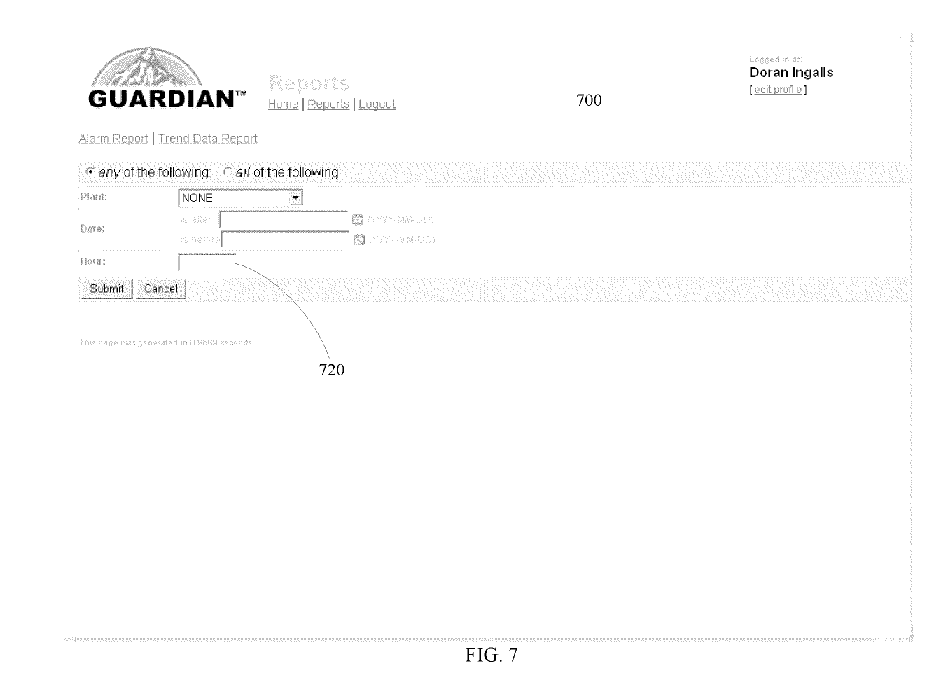

FIG. 7 shows an embodiment of a Trend Data Report selection page 700. User 30 may select a private utility, and a date range. An Hour field 720 allows a user 30 to select flow information for a specific hour of the day.

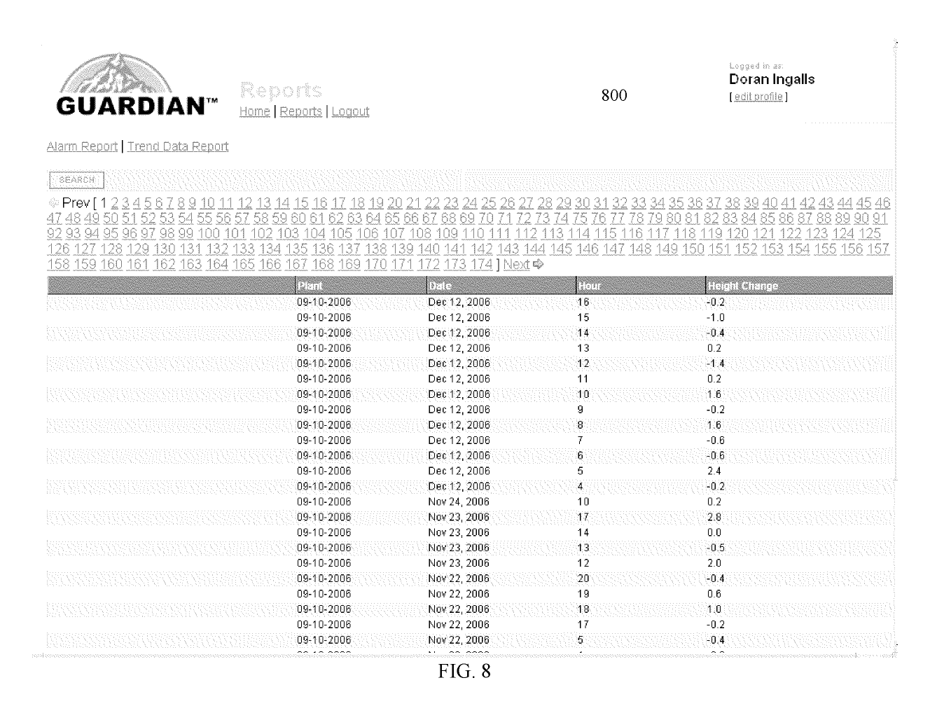

FIG. 8 shows a portion of an embodiment of a Trend Data Report 800 for a private utility 35. The height change of the private utilities is given at various dates and times. Trend reports may also be generated for other information such as the times the private utility is operational, or the use of electricity by the utility.

By highlighting and clicking onto any individual private utility 35 from list 320, information about the private utility is brought forward and details are provided, which may include drawings; photos; reports; comments; equipment specifications; site layout; daily flow trends; equipment components; operational details to the day, hour, minute and second; and status and details of any alarm or maintenance notifications sent out, to whom they are sent, and acknowledgements of the receipt of the notification.

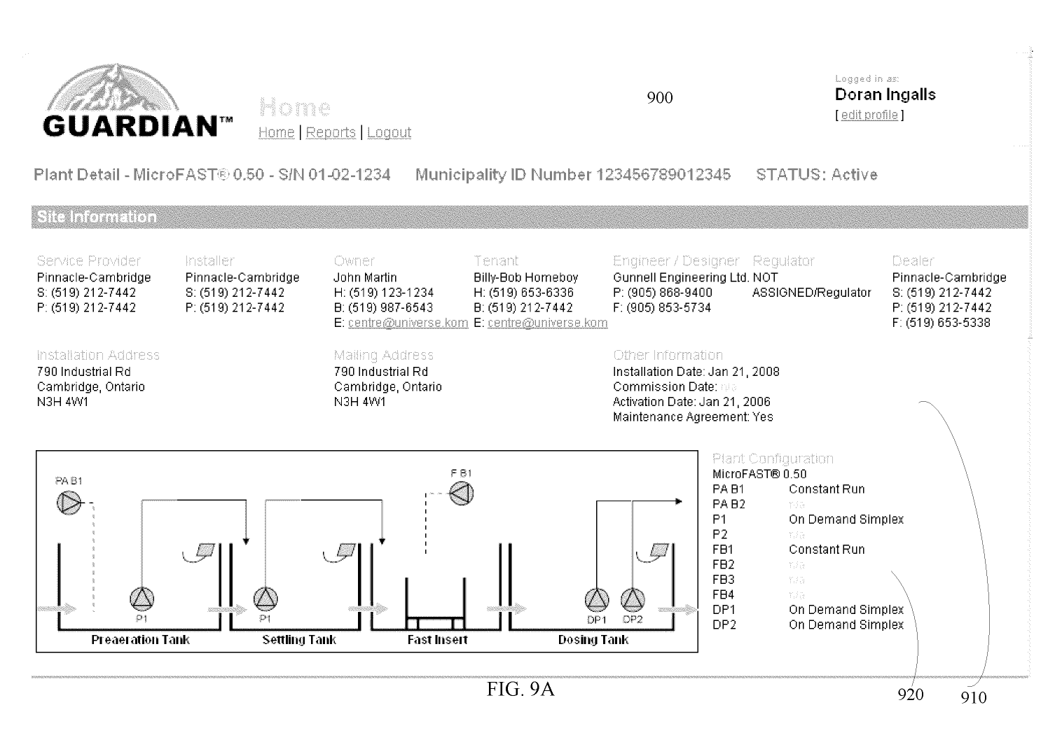

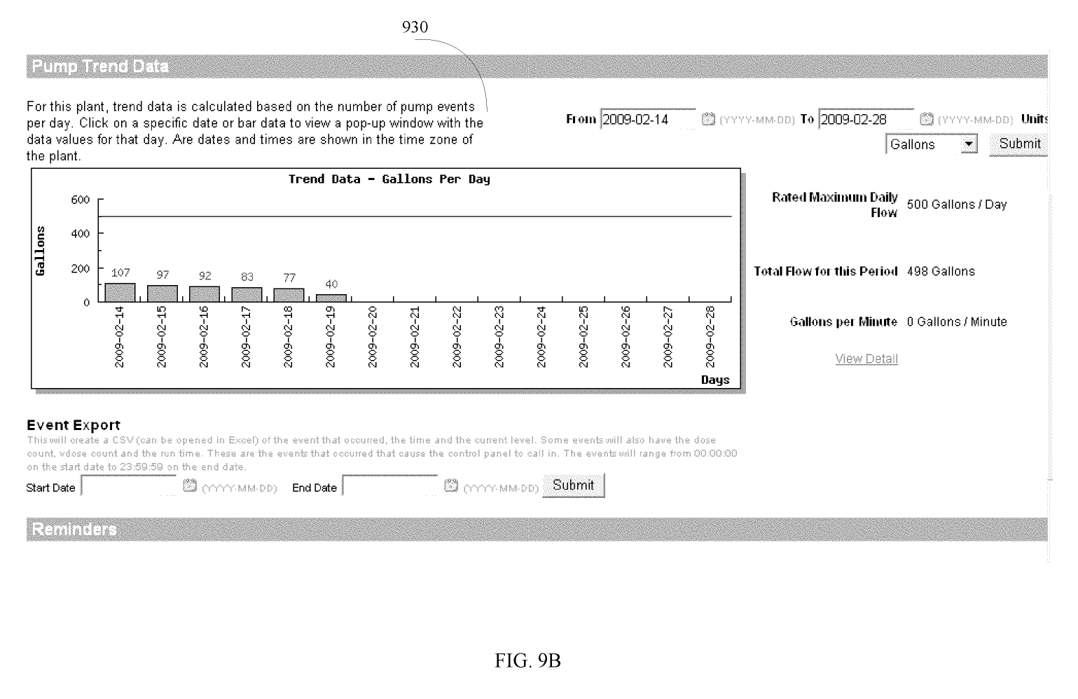

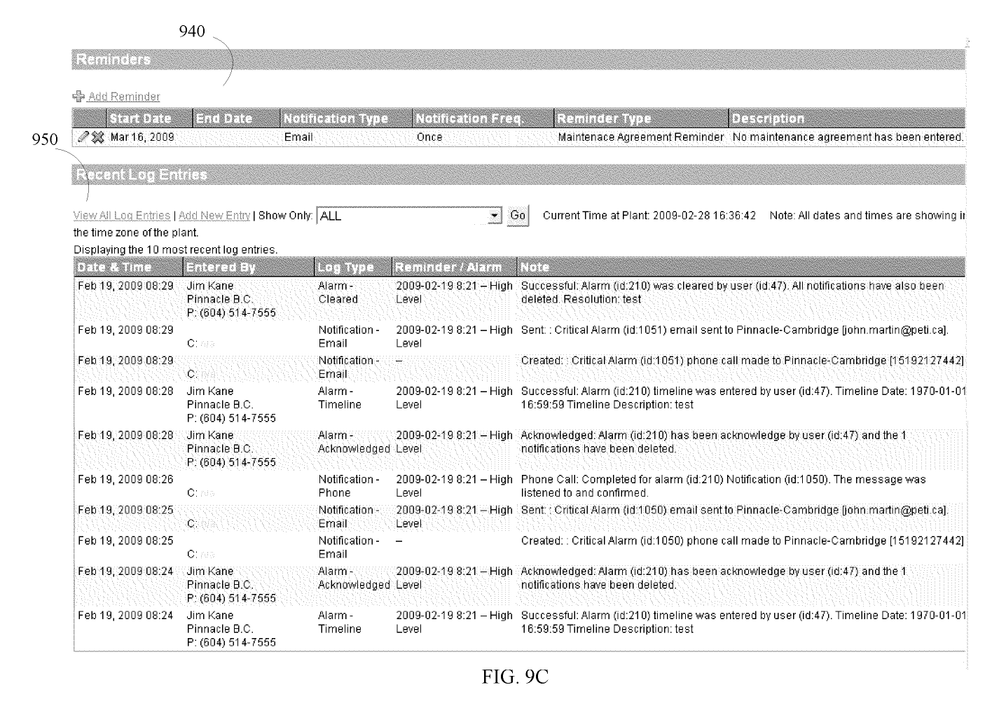

FIGS. 9A through 9C show a Site Information web page 900 providing detailed information about a private utility 35. Such information includes Site information 910 such as information about a Service Provider; Installer; Owner; Tenant; Engineer/Designer; Regulator; Dealer; Installation Address; Mailing Address; and Other Information such as Installation Date, Activation Date, and the presence of a maintenance agreement.

Site Information web page 900 may also include information about the plant configuration 920, including a figure showing the flow of the private utility 35, which in FIG. 9A, is a septic system. Trend Data 930, based on either user provided date selections and measurements, or information provided directly from the private utility via a connection to network 50, is also provided. The Trend Data may be viewable in a table format.

Reminders 940 are also displayed and new reminders can be added by user 30. Reminders can include information about the relevant Start and End Date; the Notification Type (e.g. email); the Notification Frequency (e.g. once, daily, etc.); the Reminder Type and a Description.

Also included on Site Information web page 900 are Recent Log Entries 950, including the date the entry was made, the identity of the user making the log entry; the presence of a reminder; and a note.

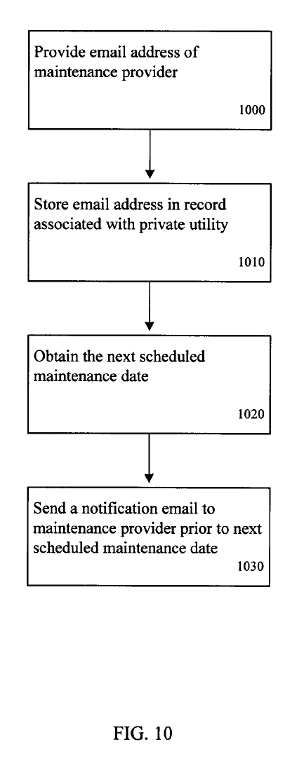

As seen in FIG. 10, the system can be used to provide notifications to users 30. In step 1000, a user 30 provides an email address, such as that of a maintenance provider, associated with a particular private utility 35 to the system. In step 1010, the system stores that email address within a record 25 associated with the private utility 35 within database 20. In step 1020, the record 25 includes a maintenance schedule associated with the private utility, including a next scheduled maintenance date. In step 1030, at a predetermined time before the next scheduled maintenance date, the server 10 sends an email notification to the maintenance provider.

Notifications are sent by server 10 by email or by telephone to the appropriate person or persons indicated in record 25. Notifications may be sent repeatedly until the notification is acknowledged. All notifications and acknowledgments are automatically recorded in the appropriate record.

The notification for scheduled maintenance is automatically sent by server 10 to the maintenance provider of record. If the notice is not responded to within the pre-set time, a second notification may be sent to the administrator and/or the regulator or owner of the utility 35.

In an embodiment of the invention, the notification of an alarm has two levels. A first level is critical wherein the response to attend to the private utility 35 site to correct the alarm is within 24 hours and the notification is sent immediately, and repeated hourly until acknowledged and the correction is noted on the corresponding record 25. The second level of alarm notification is urgent, but not critical, and the alarm notification is sent during normal business hours and corrective action is expected within 48 hours.

In the event that corrective action in response to an alarm notification has not occurred within the expected timeline, server 10 notifies the government regulator, the owner, and the designer by sending a second notification to such parties and the maintenance provider of record.

Server 10 records all activities with respect to a private utility 35 in each associated record 25 in chronological order and places the most recent activities at the top of a report.

Private utilities 35 may be able to send data directly to server 10 to update trend analysis and provide information for data logging and event recording. Server 10 receives electronic data, packets or streams in various computer languages and therefore works in conjunction with various hardware manufacturers of devices associated with private utilities 35 to upload the data stored in such hardware when data logging or event recording capacities exit within the hardware.

For the individual private utilities 35 that are not linked directly through the internet by hardware to server 10, an administrator can enter the data and information to database 20.

After the maintenance provider provides maintenance to a private utility 35, the maintenance provider can access the web site 40 and provide a maintenance date to the associated record 25. Likewise a government regulator can access web site 40 to confirm the maintenance provider has provided maintenance to private utilities within said government regulator's jurisdiction.

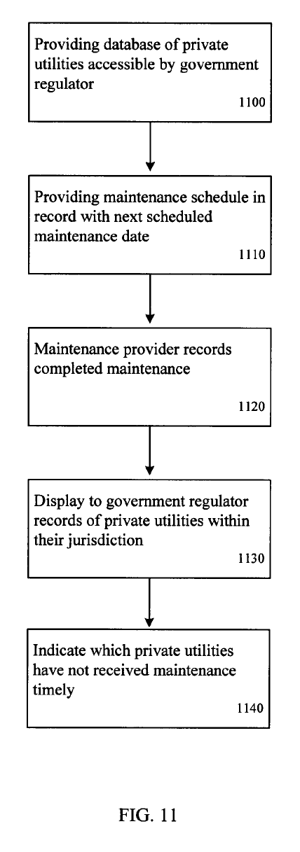

The system can also be used by a government regulator to monitor private utilities 35 sites, using the method shown in FIG. 11. In step 1100, the database 20 containing records of each private utility 35 in that government regulator's jurisdiction is accessible by the regulator. Records 25 may have a maintenance schedule with a next scheduled maintenance date (step 1110). The appropriate maintenance provider records in each record 25 when maintenance is performed on the appropriate private utility (step 1120). In step 1130, when the government regulator accesses web site 40, they are shown only those private utilities within their jurisdiction. Web site 40 indicates, through bolding, colour coding or other indicia, to the government regulator, which of those private utilities within the government regulator's jurisdiction, have not received their maintenance timely, according to the maintenance schedule (step 1140).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Aspects of the present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A system for providing notifications, comprising:
a server accessible by a computer operated by a user associated with a plurality of private utilities, said server in communication with a database, said database containing a plurality of records, each of said records relating to a private utility; said records including the date of the next scheduled maintenance of said private utility, and at least one of said records containing an email address associated with said user;
wherein within a predetermined time of said next scheduled maintenance, said server sends a notification to said user reminding said user of said next scheduled maintenance.

2. The system of claim 1 wherein said user is a maintenance provider.

3. The system of claim 2 wherein, when said maintenance provider provides maintenance to a private utility, said maintenance provider accesses said server and provides a maintenance date to said record associated with said private utility, and a government regulator may access said system to confirm said maintenance provider has provided maintenance to private utilities within said government regulator's jurisdiction.

4. The system of claim 3 wherein said record associated with a private utility includes contact information about said government regulator and an owner, and if said maintenance is not performed on said private utility according to said scheduled maintenance, then said government regulator contacts said owner.

5. The system of claim 4 wherein said record of a private utility includes repairs made to said private utility.

6. The system of claim 5 wherein said record further contains the configuration of said private utility.

7. A method of providing a notification, comprising;
a) providing an email address of a maintenance provider to a server,
b) storing said email address in a database in a plurality of records, each of said records relating to a private utility, each of said records associated with said maintenance provider;
c) for each of said records storing a maintenance schedule for said private utility, said maintenance schedules including a next scheduled maintenance date;
d) when a predetermined time occurs prior to said next scheduled maintenance date, said server sending an email notification to said maintenance provider.

8. The system of claim 7 wherein, after said maintenance provider provides maintenance to a private utility, said maintenance provider accesses said server and provides a maintenance date to said record associated with said private utility, and a government regulator accesses said server to confirm said maintenance provider has provided maintenance to private utilities within said government regulator's jurisdiction.

9. The system of claim 8 wherein said record associated with a private utility includes contact information about said government regulator and an owner, and if said maintenance is not performed on said private utility according to said scheduled maintenance, said government regulator contacts said owner.

10. The system of claim 9 wherein said record of a private utility includes repairs made to said private utility.

11. The system of claim 10 wherein said record further contains the configuration of said private utility.

12. The system of claim 11 wherein said maintenance provider generates an alarm report relating to said private utility.

13. The system of claim 12 wherein said maintenance provider generates a trend report relating to said private utility.

14. A method of monitoring a plurality of private utilities, comprising:
a) providing a database on a server accessible by a government regulator, said database containing a plurality of records, each of said records relating to a private utility; at least one of said private utilities within a jurisdiction associated with said government regulator;
b) providing a maintenance schedule for each of said private utilities, said maintenance schedule including a next scheduled maintenance date;
c) providing access to said maintenance schedule by a maintenance provider, wherein said maintenance provider records in said maintenance schedule when maintenance is performed;
d) displaying, when said government regulator accesses said site, said records relating to private utilities within the jurisdiction of said government regulator;
e) displaying to said government regulator at a web site provided by said server, a list of said private utilities within said jurisdiction, and indicating which of said private utilities have not received maintenance according to said maintenance schedule.

15. The system of claim 14 wherein said record associated with a private utility includes an email address of said maintenance provider associated with said private utility.

16. The method of claim 15 wherein said server communicates an email reminder to said maintenance provider at a predetermined time prior to said next scheduled maintenance.

17. The system of claim 16 wherein said record of a private utility includes repairs made to said private utility.

18. The system of claim 17 wherein said record further contains the configuration of said private utility.

19. The system of claim 11 wherein said government regulator generates an alarm report relating to said private utility.

20. The system of claim 12 wherein said government regulator generates a trend report relating to said private utility.
